(19) United States
(12) Patent Application Publication
(10) Pub. No.: US 2012/0186310 A1
(43) Pub. Date: Jul. 26, 2012

(54) LOCK SYSTEM FOR VEHICLES AND THE LIKE

(76) Inventor: Bruce Bacon, Rockford, MI (US)

(21) Appl. No.: 13/186,885

(22) Filed: Jul. 20, 2011

Related U.S. Application Data
(60) Provisional application No. 61/366,014, filed on Jul. 20, 2010.

(51) Int. Cl. E05B 35/10; E05B 65/00; E05B 27/00

(52) U.S. Cl. 70/77; 70/369; 70/340

(57) ABSTRACT

A lock system is provided having a lock housing and a lock barrel, a keeper shoulder, at least one full positioner shoulder, and a positioner shoulder. A lock plug is received in the barrel for rotation between locked and unlocked positions, a keyway and tumblers. The tumblers may include a key tumbler, a positioner tumbler and a keeper tumbler. The lock plug is rotatable between a first rotary position and a second rotary position. A control key is received into the keyway to retract the lock tumbler and the keeper tumbler. Included is a partial positioner shoulder, and includes a cutout portion. Removal of the lock plug from the lock barrel requires insertion of the control key in the keyway in the first rotary position and rotation of the control key and the lock plug to the second rotary position.

### CLAIM OF PRIORITY

Applicants hereby claim the priority benefits under the provisions of 35 U.S.C. §119(e), basing said claim of priority on related provisional U.S. Patent Application Ser. No. 61/366,014, filed Jul. 20, 2010.

### BACKGROUND OF THE PRESENT INVENTION

Key locks for vehicles and the like are generally well known in the art. Recreational vehicles typically have a number of key locks to control access to various areas of the vehicle, such as access doors to the vehicle's interior, closures for storage compartments, and the like. Typically, such locks are configured to accept multiple keys to facilitate providing access at dealer lots, showrooms and the like. For example, salesmen will typically require access to all lockable areas of a vehicle to properly show the vehicle to a prospective buyer. Also, customers normally want to be shown numerous vehicles before making a final selection, such that the accurate management of the numerous vehicle keys involved presents a significant challenge. Special master keys are provided to access all areas of a number of different vehicles. Also, control keys are typically provided to remove an entire lock plug from a barrel of a lock housing.

Prior lock systems are generally effective; however, certain improvements would be advantageous. For example, in prior key lock systems, when the control key is inserted into a keyway of the lock plug, the lock plug can be easily removed by simply pulling the same directly outwardly along with the associated control key. More specifically, insertion of the control key retracts tumblers, including positioning and keeper tumblers, so that the lock plug is easily removed by a single outward pulling action. As a consequence, a common pick, such as a paper clip or the like, can be used to tamper with such key locks. Essentially, the pick is inserted into the keyway of the lock plug and adjusted, so as to retract the keeper tumblers, such that outward movement of the pick will release the lock plug from the lock housing barrel, and thereby permit access to the associated vehicle compartment. Consequently, a vehicle lock system having a more secure, tamper-resistant construction would be clearly advantageous.

Accordingly, an apparatus is desired having the aforementioned advantages and solving and/or making improvements on the aforementioned disadvantages.

### SUMMARY OF THE PRESENT INVENTION

One aspect of the present invention is a lock system for vehicles and the like of the type having at least one entry closure. A lock housing is mounted adjacent the entry closure and includes a cylindrically-shaped lock barrel with at least one tumbler groove, a keeper shoulder disposed proximate an inner portion of the lock barrel, at least one full positioner shoulder, and a positioner shoulder having a channel. A cylindrically-shaped lock plug is closely received in the lock barrel for rotation between locked and unlocked positions and includes a keyway and a plurality of outwardly biased tumblers. The tumblers may include a key tumbler, a positioner tumbler disposed adjacent an outer portion of the lock plug, and a keeper tumbler disposed adjacent an inner portion of the lock plug. The lock plug is rotatable between a first rotary position and a second rotary position located a predetermined angle from the first rotary position. A control key is received into the keyway to retract the lock tumbler and the keeper tumbler. Included is a partial positioner shoulder having an inner end disposed proximate the inner portion of the lock plug, an outer end disposed proximate the outer portion of the lock plug and includes a cutout portion rotationally aligned with the positioner tumbler when assembled with a tip and a cutout face. Removal of the lock plug from the lock barrel requires insertion of the control key in the keyway in the first rotary position and rotation of the control key and the lock plug to the second rotary position, thereby permitting axial shifting of the lock plug out of the lock barrel.

Another aspect of the present invention is a lock system for an entry closure. A lock housing is mounted adjacent the entry closure and includes a cylindrically-shaped lock barrel with at least one tumbler groove, a keeper shoulder disposed proximate an inner portion of the lock barrel, at least one full positioner shoulder, and a positioner shoulder having a substantially U-shaped channel. A cylindrically-shaped lock plug is closely received in the lock barrel for rotation between locked and unlocked positions, and includes an axially extending keyway and a plurality of radially shiftable outwardly biased tumblers. The tumblers may include a key tumbler, a positioner tumbler disposed adjacent to an outer portion of the lock plug, and a keeper tumbler disposed adjacent an inner portion of the lock plug. A control key is received into the keyway to retract the lock tumbler and the keeper tumbler. A master key is received into the keyway to retract the lock tumbler and the positioner tumbler. A customer key is received into the keyway to retract the positioner tumbler and the lock tumbler. A partial positioner shoulder includes and extends from an inner end disposed proximate the keeper shoulder to an outer end disposed proximate the outer portion of the lock plug, where the outer end includes a cutout portion.

A further aspect of the present invention is a lock system for vehicle entry closures. A lock housing is mounted adjacent the entry closure and includes a cylindrically-shaped lock barrel with a plurality of tumbler grooves, a keeper shoulder disposed proximate an inner portion of the lock barrel, and at least one full positioner shoulder. A cylindrically-shaped lock plug is closely received in the lock barrel for rotation between locked and unlocked positions, and includes an axially extending keyway and a plurality of radially shiftable outwardly biased tumblers. The tumblers may include a key lock tumbler, a positioner tumbler disposed adjacent an outer portion of the lock plug, and a keeper tumbler disposed adjacent an inner portion of the lock plug, where the keeper tumbler includes a radially extending locator that is axially aligned with one of the plurality of tumbler grooves, the lock plug having a first rotary position and a second rotary position. A first key is closely received into the keyway to retract the lock tumbler and the keeper tumbler. A partial positioner shoulder includes and extends from an inner end proximate the keeper shoulder to an outer end including a cutout portion. Removal of the lock plug from the lock barrel requires insertion of the first key into the keyway in the first rotary position and rotation of the first key and the lock plug to the second rotary position, thereby permitting axial shifting of the lock plug out of the lock barrel.

These and other advantages of the invention will be further understood and appreciated by those skilled in the art by reference to the following written specification, claims and appended drawings.

### BRIEF DESCRIPTION OF THE DRAWINGS

In the drawings:

FIG. 1 contains partially schematic plan views of a prior lock system for vehicles and the like, wherein a lock plug has been removed from a lock barrel;

FIG. 2 contains partially schematic plan views of a first embodiment of an improved lock system for vehicles and the like, wherein the lock plug has been removed from the lock barrel;

FIG. 3 is a perspective view of the prior lock system, wherein the lock plug has been removed from the lock barrel;

FIG. 4 is a perspective view of the improved lock system illustrating the first embodiment of the present invention, wherein the lock plug has been removed from the lock barrel;

FIG. 5 contains perspective views of the first embodiment of the lock plug and a control key before insertion into the lock plug;

FIG. 6 contains perspective views of the lock plug and the control key after insertion into the lock plug;

FIG. 7 contains partially schematic plan views of a second embodiment of an improved lock system for vehicles and the like, wherein the lock plug has been removed from the lock barrel;

FIG. 8 is a perspective view of the second embodiment of the improved lock system for vehicles and the like, wherein the lock plug has been removed from the lock barrel;

FIG. 9 is a perspective view of the lock barrel of the second embodiment;

FIG. 10 is a perspective view of the lock plug of the second embodiment with a control key inserted into the lock plug;

FIG. 11 is a perspective view of the lock plug of the second embodiment with a master key inserted into the lock plug;

FIG. 12 is a perspective view of the lock plug of the second embodiment with a customer key inserted into the lock plug; and

FIG. 13 is a perspective view of the second embodiment of the improved lock system, including a cam that is rotatable between locked and unlocked positions.

### DETAILED DESCRIPTION OF EMBODIMENTS

For purposes of description herein, the terms “upper,” “lower,” “right,” “left,” “rear,” “front,” “vertical”, “horizontal” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

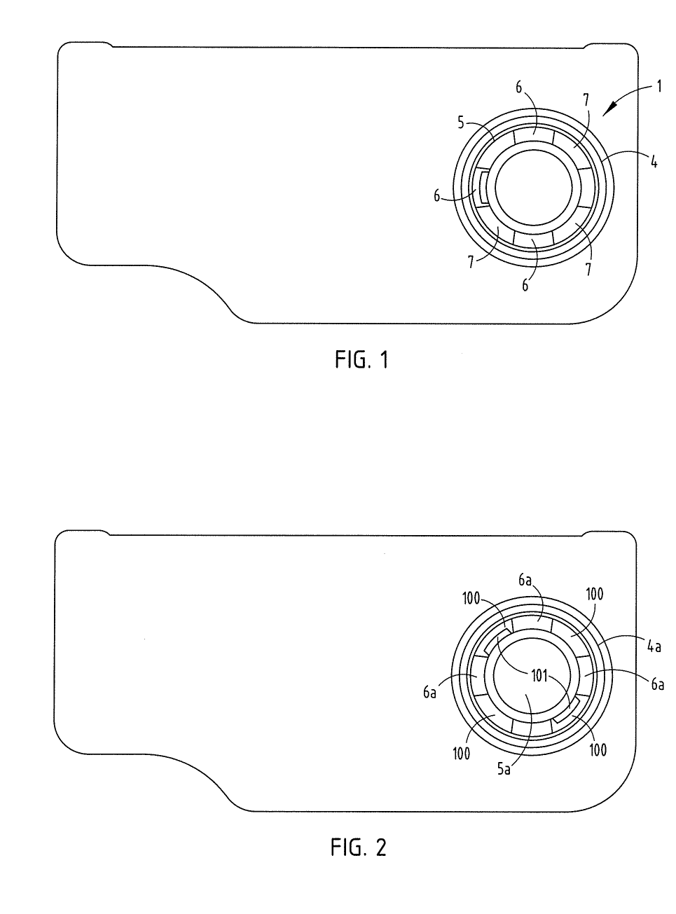

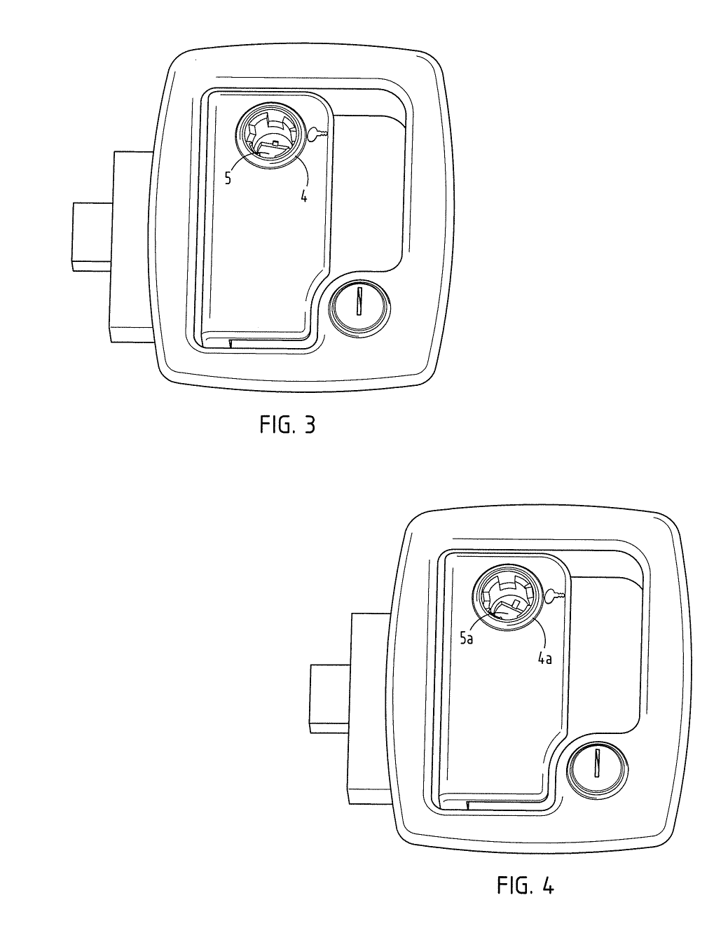

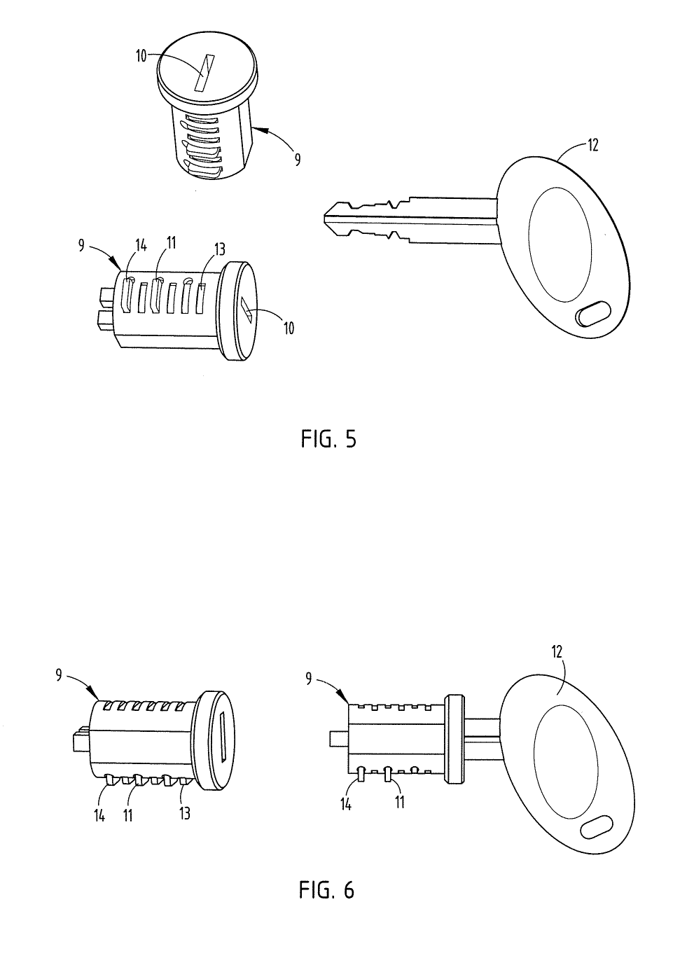

The reference numeral 1 (FIGS. 1 and 3) illustrates a prior lock system that is disclosed in commonly owned U.S. Pat. No. 6,701,761, the disclosure of which is hereby incorporated by reference in its entirety, over which the present invention is an improvement. The prior lock system 1 includes a lock housing 4 disposed in the rotating paddle handle portion of the assembly, a lock barrel 5, and four tumbler grooves 6 with four solid positioner shoulders 7 disposed at right angles to one another. As disclosed in FIGS. 5 and 6, the lock plug 9 includes a plurality of spring loaded key or lock wafers or tumblers 11 which prevent the lock plug 9 from rotating in the lock barrel 5 unless an associated key is inserted therein. A positioner tumbler 13 is located axially outward of the key or lock tumblers 11 and also serves to prevent rotation of the lock plug 9 in the lock barrel 5 unless a specific key is inserted in a keyway 10 of the lock plug 9. The lock plug 9 also includes an outer keeper tumbler 14, which prevents the lock plug 9 from being removed axially from the lock barrel 5, unless a control key is inserted into the keyway 10.

As best illustrated in FIG. 1, when a control key 12 is inserted into the keyway 10 of the lock plug 9, the entire lock plug 9 can be removed axially from the associated lock barrel 5 by simply pulling the key 12, along with the lock plug 9 thereon, directly outwardly.

The reference numeral la generally designates a lock system embodying the present invention, and having a tamper-resistant construction with improved security. Similar parts appearing in FIGS. 1 and 3, and the group of FIGS. 2 and 4-6, respectively, are represented by same, corresponding reference numerals, except for the suffix “a” in the numerals of the latter group. In the improved lock system la, two of four generally trapezoidal positional shoulders 100 disposed between the four tumbler grooves 6a include an inwardly facing, U-shaped channel 101 which is configured to permit the exterior ends of the tumblers 11a, 13a and 14a to pass therethrough. The channels 101 are disposed diametrically opposite to one another, at an angle of approximately 45 degrees from the next adjacent tumbler grooves 6a. The associated lock plug 9a is similar to the previously described lock plug 9, and is configured such that it can be removed from the associated lock barrel 5a only when the lock plug 9a has been rotated 45 degrees with respect to the neutral position of the lock plug 9a, so that the tumblers 11a, 13a and 14a are aligned with the channels 101.

In operation, when the control key 12a is inserted into the keyway 10a of the lock system la, the lock plug 9a cannot be removed by simply pulling the control key 12a and associated lock plug 9a directly axially outwardly. A keeper tumbler 14a can remain engaged in the lock barrel 5a to prevent direct outward axial motion of the lock plug 9a from the lock barrel 5a. Rather, the control key 12a and associated lock plug 9a must be rotated 45 degrees from the neutral position, as shown in FIG. 2, so that all tumblers 11a, 13a and 14a are aligned in the two channels 101 before the lock plug 9a can be shifted axially out of the associated lock barrel 5a. Hence, even if a common pick is used to retract the keeper tumbler 14a of lock plug 9a, the lock plug 9a cannot be removed until the lock plug 9a is rotated 45 degrees, which is very difficult, if not impossible, when using a common pick. A highly specialized pick would need to be constructed to retract all of the tumblers 11a, 13a and 14a, and then rotate the same 45 degrees to remove the lock plug 9a. Consequently, lock system la has a tamper-resistant construction, which provides improved the overall lock security.

Therefore, once all of the tumblers 11a, 13a and 14a are retracted, the lock plug 9a can rotate, but it is difficult to retract all of the wafers or tumblers 11a, 13a and 14a. It is very simple to retract the keeper tumbler 14a. Even with this new design keeper tumbler 14a, it can easily be retracted. However, the lock plug 9a must be rotated 45 degrees to remove because there is a small portion on keeper tumbler 14a that remains exposed even when this tumbler 14a is retracted. In other words, since the keeper tumbler 14a is retracted, it must line up with the channels 101 at the 45 degree angle for this exposed portion of the keeper tumbler 14a to be pulled axially from the lock barrel 5a, and in order to remove this lock plug 9a, the tumblers 11a, 13a and 14a must be retracted, rotated, and removed.

The reference numeral 1b generally designates another embodiment of a lock system embodying the present invention, and having a tamper-resistant construction with improved security. Similar parts appearing in FIGS. 1-6 and FIGS. 7-10, respectively, are represented by same, corresponding reference numerals, except for the suffix “b” in the numerals of the latter. The lock system 1b (FIG. 13) is configured to lock and unlock a paddle lock by having the lock plug 9b and the lock barrel 5b interact with a lock cam 230. Upon manipulation of the lock plug 9b by a key, the cam 230 is rotated between locked and unlocked positions, thereby preventing and allowing paddle rotation, respectively.

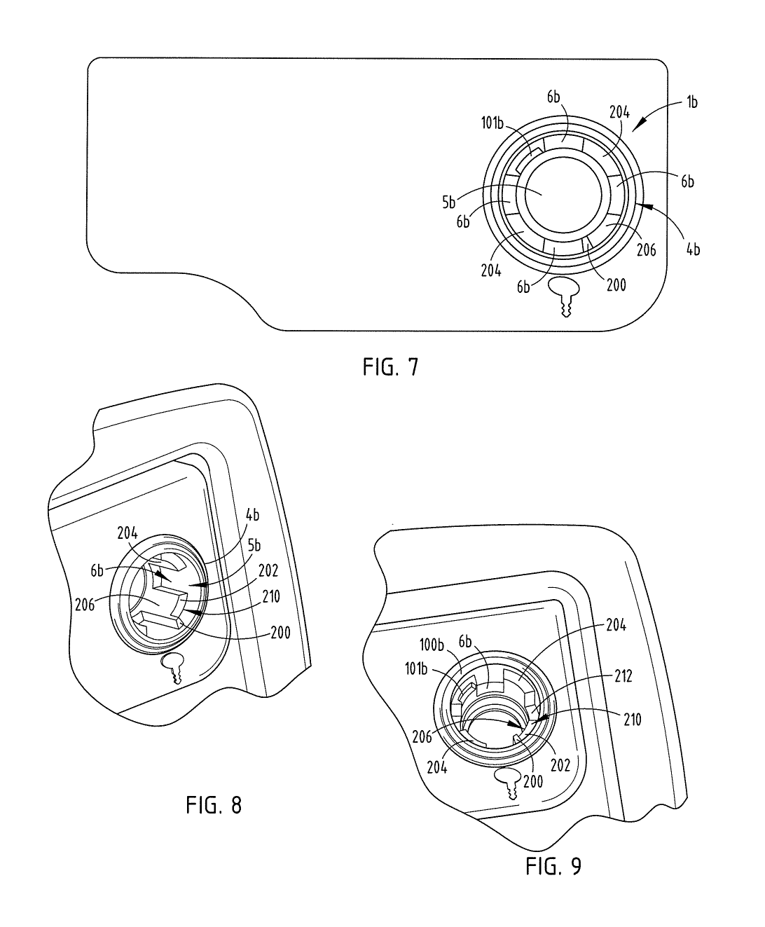

Referring to FIGS. 7-9, in the improved lock system 1b, a keeper shoulder 212 extends circumferentially around the lock barrel 5b at a location proximate the inner end of the lock barrel 5b. The lock barrel 5b also includes one generally trapezoidal positional shoulder 100b disposed between two of the four tumbler grooves 6b and includes an inwardly facing, U-shaped channel 101b which is configured to permit the exterior ends of the tumblers 11b, 13b and 14b to pass therethrough. The channel 101b is disposed diametrically opposite to a partial positioner shoulder 206, with both the partial positioner shoulder 206 and the U-shaped channel 101b at an angle of approximately 45 degrees from the next adjacent respective tumbler grooves 6b. Both the channel 101b and the partial positioner shoulder 206 are at an angle of approximately 90 degrees from adjacent full positioner shoulders 204. The full positioner shoulders 204 are similarly of a generally trapezoidal geometry, but do not contain a U-shaped channel or indentation of any type.

The partial positioner shoulder 206 is also of a generally trapezoidal geometry, such that it does not contain a channel or indentation. The partial positioner shoulder 206 is distinct from the previously described shoulders, 100b, 204, based on a cutout portion 210 that includes a void in the trapezoidal shape at an outer end of the partial positioner shoulder 206. The cutout portion 210 is defined by a tip 200 that extends axially outward to a position in the lock barrel 5b that is proximate that of the outer end of the full positioner shoulders 204 and positioner shoulder 100b. The outer end of the partial positioner shoulder 206 is therefore defined by the tip 200, which juts axially inward, with respect to the lock barrel 5b, and radially away from the tip 200, with the portion axially inward of the tip 200 defining a cutout face 202. The cutout portion 210 is axially aligned to allow the positioner tumbler 13b to rotate within the lock barrel 5b between an adjacent full positioner shoulder 204 and the tip 200 of the cutout portion 210.

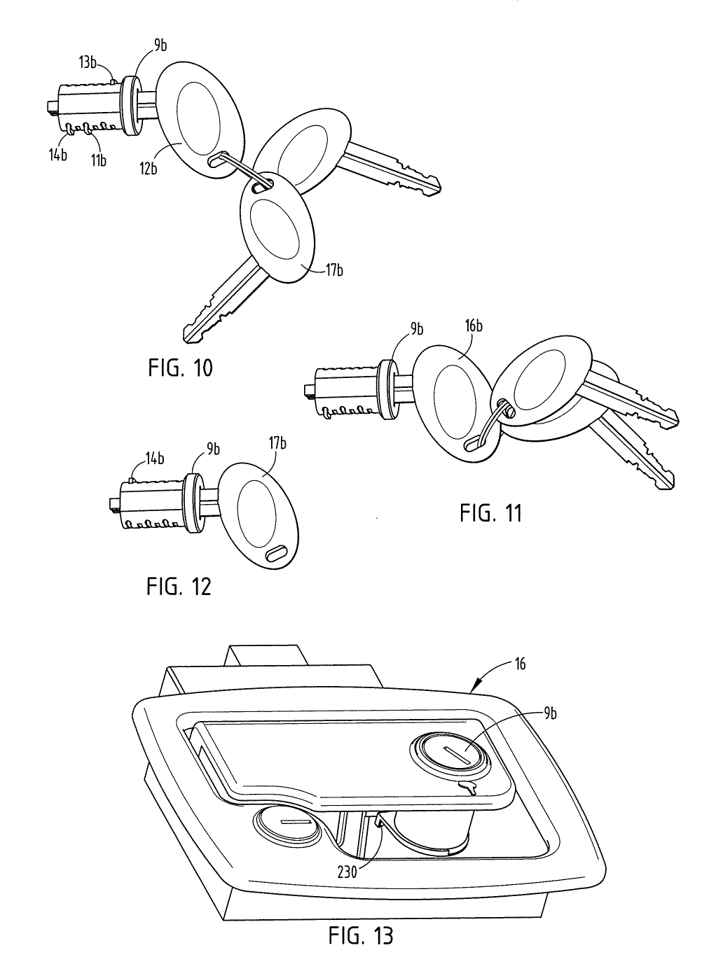

Referring to FIG. 10, the associated lock plug 9b is similar to the previously described lock plug 9, and is configured to include a plurality of slots 216 that house the tumblers 11b, 13b and 14b. The lock plug 9b is also similarly configured, such that it can be removed from the associated lock barrel 5b only when the lock plug 9b has been rotated 45 degrees from a first rotary position with respect to the neutral position of the lock plug 9b, to a second rotary position, such that the tumblers lib, 13b and 14b are aligned with the channel 101b. The first embodiment of the present invention described above and illustrated in FIGS. 2 and 4-6, although requiring rotation of the lock plug 9b, does not permit the control key 12b to rotate the lock plug 9b. Rather, an additional key, such as a master key 16b is required to rotate the lock plug 9b into a specified position prior to insertion of the control key 12b that facilitates axial removal of the lock plug 9b. The cutout portion 210 of the second embodiment allows rotation of the lock plug 9b by the control key 12b. Insertion of the control key 12b into the keyway leaves a portion of the positioner tumbler 13b radially outward of the slots 216 of the lock plug 9b. The portion of the positioner tumbler 13b that protrudes outward is located proximate the cutout portion 210 of the lock plug 9b.

In addition to the control key 12b and master key 16b, the lock system 1b includes a customer key 17b. The construction of each key is described in detail in U.S. Pat. No. 6,701,761, which, as stated previously, has been incorporated in its entirety to this specification. The master key 16b (FIG. 11) is inserted into the keyway 10b of the lock plug 9b to retract the lock tumblers 11b and the positioner tumbler 13b. The customer key 17b (FIG. 12) is inserted into the keyway 10b of the lock plug 9b to similarly retract the lock tumblers 11b and the positioner tumbler 13b.

In operation, when a control key 12b is inserted into the keyway 10b of the lock system 1b, the lock plug 9b cannot be removed by simply pulling the control key 12b and associated lock plug 9b directly axially outwardly. The keeper tumbler 14b can remain engaged in the lock barrel 5b to prevent direct outward axial motion of the lock plug 9b from the lock barrel 5b. Rather, the control key 12b and associated lock plug 9b must be rotated 45 degrees from the neutral position, as shown in FIG. 2, so that the tumblers 11b, 13b, and 14b are aligned in the channel 101b before the lock plug 9b can be shifted axially out of the associated lock barrel 5b. Hence, even if a common pick is used to retract the keeper tumbler 14b of lock plug 9b, the lock plug 9b cannot be removed until the lock plug 9b is rotated 45 degrees, which is very difficult, if not impossible, when using a common pick. A highly specialized pick would need to be constructed to retract all of the tumblers 11b, 13b and 14b, and then rotate the same 45 degrees to remove the lock plug 9b. Consequently, lock system 1b has a tamper-resistant construction, which provides improved the overall lock security, while also allowing a single key, the control key 12b, to rotate and remove the lock plug 9b.

In the foregoing description, it will be readily appreciated by those skilled in the art that modifications may be made to the invention without departing from the concepts disclosed herein. Such modifications are to be considered as included in the following claims, unless these claims by their language expressly state otherwise.

What is claimed is:

1. In a lock system for vehicles and the like of the type having at least one entry closure, comprising:
a lock housing for mounting adjacent the entry closure and including a cylindrically-shaped lock barrel with at least one tumbler groove extending axially therealong, a keeper shoulder disposed proximate an inner portion of said lock barrel, at least one full positioner shoulder, and a positioner shoulder having a channel;
a cylindrically-shaped lock plug shaped for close reception in said lock barrel for rotation between locked and unlocked positions, and including an axially extending keyway and a plurality of radially shiftable outwardly biased tumblers, comprising at least one key actuated tumbler, a positioner tumbler disposed adjacent to an outer portion of said lock plug, and a keeper tumbler disposed adjacent to an inner portion of said lock plug, wherein the lock plug includes a first rotary position and a second rotary position located a predetermined angle from said first rotary position;
a control key having a shank portion shaped for close reception in said keyway with a plurality of bits configured to retract only said lock tumbler and said keeper tumbler;
a partial positioner shoulder having an inner end disposed proximate said inner portion of said lock plug, an outer end disposed proximate the outer portion of said lock plug and including a cutout portion rotationally aligned with said positioner tumbler when assembled with a tip and a cutout face; and
whereby removal of said lock plug from said lock barrel requires insertion of said control key in said keyway in said first rotary position and rotation of said control key and said lock plug to the second rotary position, thereby permitting axial shifting of said lock plug out of said lock barrel for repair or replacement.

2. The lock system of claim 1, further comprising:
a master key having a shank portion shaped for close reception in said keyway with a plurality of bits configured to retract said lock tumbler and said positioner tumbler; and
a customer key having a shank portion shaped for close reception in said keyway with a plurality of bits configured to retract only said positioner tumbler and said lock tumbler.

3. The lock system of claim 2, wherein the tip extends to the outer end of the partial positioner shoulder, and wherein the tip is axially outward of the cutout face of the cutout portion.

4. The lock system of claim 3, wherein the cutout portion is configured to allow the positioner tumbler to rotate within the cutout portion between the tip of the partial positioner shoulder and an adjacent full positioner shoulder.

5. The lock system of claim 4, wherein said lock barrel includes a plurality of tumbler grooves extending axially therealong.

6. The lock system of claim 5, wherein said keeper shoulder includes a locator that is aligned with said channel.

7. The lock system of claim 6, wherein said keeper tumbler is positioned for abutting contact with said keeper shoulder in the first rotary position and wherein said keeper tumbler is rotationally aligned with said locator in the second rotary position.

8. The lock system of claim 2, wherein said lock plug is configured so that it cannot be removed from said lock housing by said master key.

9. The lock system of claim 2, wherein said lock housing includes a cam which rotates between locked and unlocked positions to selectively retain the entry closure in a locked position.

10. The lock system of claim 1, wherein said tumblers comprise spring biased wafer tumblers, and wherein said lock plug includes a plurality of said lock tumblers.

11. A lock system for an entry closure, comprising:
a lock housing for mounting adjacent the entry closure and including a cylindrically-shaped lock barrel with at least one tumbler groove extending axially therealong, a keeper shoulder disposed proximate an inner portion of said lock barrel, at least one full positioner shoulder, and a positioner shoulder having a substantially U-shaped channel;
a cylindrically-shaped lock plug shaped for close reception in said lock barrel for rotation between locked and unlocked positions, and including an axially extending keyway and a plurality of radially shiftable outwardly biased tumblers, comprising at least one key actuated tumbler, a positioner tumbler disposed adjacent to an outer portion of said lock plug, and a keeper tumbler disposed adjacent to an inner portion of said lock plug;
a control key having a shank portion shaped for close reception in said keyway with a plurality of bits configured to retract only said lock tumbler and said keeper tumbler;
a master key having a shank portion shaped for close reception in said keyway with a plurality of bits configured to retract said lock tumbler and said positioner tumbler;
a customer key having a shank portion shaped for close reception in said keyway with a plurality of bits configured to retract only said positioner tumbler and said lock tumbler; and
a partial positioner shoulder including and extending from an inner end disposed proximate said keeper shoulder to an outer end disposed proximate said outer portion of said lock plug, wherein said outer end includes a cutout portion.

12. The lock system of claim 11, wherein the partial positioner shoulder includes a tip that extends to the outer end of the partial positioner shoulder, wherein the tip is axially outward of a cutout face of the cutout portion.

13. The lock system of claim 12, wherein the cutout portion is configured to allow the positioner tumbler to rotate within the cutout portion between the tip of the partial positioner shoulder and an adjacent full positioner shoulder.

14. The lock system of claim 13, wherein said lock barrel includes a plurality of tumbler grooves extending axially therealong.

15. The lock system of claim 14, wherein said keeper shoulder includes a locator that is aligned with said U-shaped channel.

16. The lock system of claim 15, wherein said keeper tumbler is positioned for abutting contact with said keeper shoulder in the first rotary position and wherein said keeper tumbler is rotationally aligned with said locator in the second rotary position.

17. The lock system of claim 16, wherein said lock plug is configured to be removed from said lock housing by insertion of the shank portion of said control key into said keyway of said lock plug when said lock plug is in said first rotary position in said lock barrel to retract said keeper tumbler, and rotating the lock plug to said second rotary position, thereby permitting axial shifting of said lock plug out of said lock barrel for repair or replacement.

18. A lock system for vehicle entry closures, comprising:
a lock housing for mounting adjacent the entry closure and including a cylindrically-shaped lock barrel with a plurality of tumbler grooves extending axially therealong, a keeper shoulder disposed proximate an inner portion of said lock barrel, and at least one full positioner shoulder;
a cylindrically-shaped lock plug shaped for close reception in said lock barrel for rotation between locked and unlocked positions, and including an axially extending keyway and a plurality of radially shiftable outwardly biased tumblers, comprising at least one key actuated lock tumbler, a positioner tumbler disposed adjacent to an outer portion of said lock plug, and a keeper tumbler disposed adjacent to an inner portion of said lock plug, wherein said keeper tumbler includes a radially extending locator that is axially aligned with one of said plurality of tumbler grooves, said lock plug having a first rotary position in said lock barrel, wherein said keeper tumbler is positioned for abutting contact with said keeper shoulder and a second rotary position, wherein said keeper tumbler is axially aligned with said radially extending locator;
a first key having a shank portion shaped for close reception in said keyway with a plurality of bits configured to retract only said lock tumbler and said keeper tumbler;
a partial positioner shoulder including and extending from an inner end located proximate said keeper shoulder to an outer end including a cutout portion; and
whereby removal of said lock plug from said lock barrel requires insertion of said first key in said keyway in said first rotary position and rotation of said first key and said lock plug to the second rotary position, thereby permitting axial shifting of said lock plug out of said lock barrel for repair or replacement.

19. The lock system of claim 19, further comprising:
a second key having a shank portion shaped for close reception in said keyway with a plurality of bits configured to retract said lock tumbler and said positioner tumbler; and
a third key having a shank portion shaped for close reception in said keyway with a plurality of bits configured to retract only said positioner tumbler and said lock tumbler.

20. The lock system of claim 18, wherein the partial positioner shoulder includes a tip that extends to the outer end of the partial positioner shoulder, wherein the tip is axially outward of a cutout face of the cutout portion, and wherein the cutout portion is configured to allow the positioner tumbler to rotate within the cutout portion between the tip of the partial positioner shoulder and an adjacent full positioner shoulder.
